(19) United States
(12) Patent Application Publication
(10) Pub. No.: US 2025/0234996 A1
(43) Pub. Date: Jul. 24, 2025

(54) MOVING FOOT BASE OF FURNITURE

(71) Applicant: US GINZZU INC, HOUSTON, TX (US)

(72) Inventor: Yindi Yu, Shangrao (CN)

(21) Appl. No.: 19/177,487

(22) Filed: Apr. 11, 2025

(51) Int. Cl. A47B 91/00; B60B 33/00

(52) U.S. Cl. CPC A47B 91/005; B60B 33/0002; B60B 2200/20

(57) ABSTRACT

A moving foot base of furniture comprises a base body, a center of the base body being provided with an accommodating cavity; universal wheels mounted at a bottom portion of the base body, and rotatably connected with the base body; and a tray, the base body and the universal wheels being all arranged on the tray. According to the moving foot base of furniture, a supporting foot of furniture is placed in the accommodating cavity in the base body, and then the universal wheels are mounted at the bottom portion of the base body to realize movement through the universal wheels to move high-mass furniture easily; and the tray is further arranged below the universal wheels, and the tray with a large area loads the furniture to reduce a pressure on a floor caused by the high-mass furniture, thereby avoiding the floor from being damaged.

### TECHNICAL FIELD

The present invention relates to the technical field of furniture fittings, in particular to a moving foot base of furniture.

### BACKGROUND OF THE PRESENT INVENTION

In the field of household interior decoration furniture, a lot of furniture such as sofas, tables and wardrobes, or appliances such as refrigerators often need to be moved for cleaning or rearrangement to make an indoor environment more beautiful and creative. However, the furniture is usually bulky and heavy, and it is difficult for a person to move it independently, which not only is not conducive to work efficiency, but also may bring security risks.

Moreover, because different families have different ground environments, different furniture moving strategies also need to be formulated when there are different ground environments. There are still the following problems in the use of the existing moving foot base of furniture: 1. a floor surface may be scratched when moving the furniture, especially when the moving foot base of furniture is used on a hard floor; 2. when the furniture does not need to be moved, a greater pressure may be exerted on the floor; and 3. the moving foot base of furniture lacks flexibility, and is difficult to adapt to furniture with different weights and sizes.

Therefore, it is an urgent problem for those skilled in the art to design a moving foot base of furniture which can not only move furniture conveniently, but also better protect the indoor floor from being damaged.

### SUMMARY OF THE PRESENT INVENTION

In view of this, the present invention aims to provide a moving foot base of furniture, so that different types of furniture can be moved easily without damaging a floor.

The present invention provides a moving foot base of furniture, which comprises:
a base body, wherein a center of the base body is provided with an accommodating cavity;
universal wheels, wherein the universal wheels are mounted at a bottom portion of the base body, and the universal wheels are rotatably connected with the base body; and
a tray, wherein the base body and the universal wheels are all arranged on the tray.

In one embodiment, the tray is provided with a limiting plate, and the limiting plate is provided with an inserting hole.

In one embodiment, the moving foot base of furniture further comprises a latch, wherein the latch penetrates through the limiting plate via the inserting hole.

In one embodiment, the latch comprises side inserting rods and a middle inserting rod;
the inserting hole comprises side inserting ports and a middle inserting port; and
the middle inserting rod penetrates through the middle inserting port, and the side inserting rods penetrate through the side inserting ports.

In one embodiment, when the latch completely penetrates through the limiting plate via the inserting hole, a wheel accommodating groove is formed among the middle inserting rod, the side inserting rods and the limiting plate, the universal wheels are limited in the wheel accommodating grooves, and the universal wheels are in a non-rollable state.

In one embodiment, the latch is further provided with a handle, and when the universal wheels are in the non-rollable state, the handle is used for removing the latch;
an edge of the tray is provided with a pulling portion, and when the universal wheels are in the non-rollable state, the pulling portion is used for removing the tray; and
when the tray and the latch are both removed, the universal wheels are in a rollable state.

In one embodiment, when the latch completely penetrates through the limiting plate via the inserting hole, a first edge of the latch is aligned with a first edge of the tray.

In one embodiment, the pulling portion is arranged obliquely upwards; and the pulling portion is provided with a pulling hole.

In one embodiment, an end face of the handle is further provided with a friction portion, and the friction portion protrudes from the end face of the handle.

In one embodiment, a bottom face of the tray is a plane.

In one embodiment, the tray is made of a hard material.

In one embodiment, a surface of the latch oriented to the universal wheels is cambered, so as to be fit with the universal wheels.

In one embodiment, a cushion pad is further arranged in the accommodating cavity.

In one embodiment, one end of the latch has a chamfered structure.

In the moving foot base of furniture provided by the embodiment of the present invention, a supporting foot of furniture is placed in the accommodating cavity in the base body, and then the universal wheels are mounted at the bottom portion of the base body to realize movement through the universal wheels, so as to move high-mass furniture easily. Moreover, the tray is further arranged below the universal wheels, and the tray with a large area loads the furniture, so as to reduce a pressure on a floor caused by the high-mass furniture, thereby avoiding the floor from being damaged.

### DESCRIPTION OF THE DRAWINGS

In order to illustrate the technical solutions of embodiments of the present invention more clearly, the drawings which need to be used in the embodiments will be briefly introduced hereinafter. It should be understood that the following drawings only show some embodiments of the present invention, so that the drawings should not be regarded as limiting the scope. Those of ordinary skills in the art may further obtain other related drawings according to these drawings without going through any creative work.

FIG. 1 is a schematic structural diagram of a moving foot base of furniture according to one embodiment of the present invention;

FIG. 2 is a side view of the moving foot base of furniture according to one embodiment of the present invention;

FIG. 3 is an exploded view of the moving foot base of furniture according to one embodiment of the present invention;

FIG. 4 is a bottom view of the moving foot base of furniture according to one embodiment of the present invention after being exploded;

FIG. 5 is a side view of the moving foot base of furniture according to one embodiment of the present invention after being exploded;

FIG. 6 is a top view of a base body according to one embodiment of the present invention;

FIG. 7 is a schematic diagram of the base body and universal wheels according to one embodiment of the present invention after being assembled;

FIG. 8 is a schematic structural diagram of a tray according to one embodiment of the present invention;

FIG. 9 is a schematic diagram of a bottom face of the tray according to one embodiment of the present invention;

FIG. 10 is a schematic structural diagram of a latch according to one embodiment of the present invention;

FIG. 11 is a side view of the latch according to one embodiment of the present invention;

FIG. 12 is a schematic diagram of the latch aligned with an inserting hole according to one embodiment of the present invention;

FIG. 13 is a schematic diagram of the latch and the tray according to one embodiment of the present invention after being assembled;

FIG. 14 is a schematic diagram of the universal wheels and the tray according to one embodiment of the present invention after being assembled; and

FIG. 15 is a schematic diagram of the universal wheels according to one embodiment of the present invention after entering the tray.

### DETAILED DESCRIPTION OF PREFERRED EMBODIMENTS

Specific embodiments of the present invention are described in detail hereinafter with reference to the drawings. Obviously, the embodiments described are merely a part of, rather than all of, the embodiments of the present invention. Based on the description of the present invention, all other embodiments obtained by those of ordinary skills in the art without going through any creative work should fall within the scope of protection of the present invention.

In the description of the present invention, the terms “arrangement”, “installation”, “connection” and the like should be understood in a broad sense unless otherwise clearly specified and defined. For example, they may be fixed connection, removable connection or integrated connection; may be mechanical connection or electrical connection; and may be direct connection or indirect connection through an intermediate medium. The specific meanings of the above terms may be understood in a specific case by those of ordinary skills in the art.

If the orientation or position relationship indicated by the terms “upper”, “lower”, “left”, “right”, “front”, “rear”, “top”, “bottom”, “inner”, “outer”, and the like is based on the orientation or position relationship shown in the drawings, or the orientation or position relationship of the product of the present invention in use, it is only for the convenience of description and simplification of the description, and it is not to indicate or imply that the indicated device or element must have a specific orientation, and be constructed and operated in a specific orientation. Therefore, the terms should not be understood as limiting the present invention.

The terms “first”, “second”, “third”, and the like are used for distinguishing components with similar properties only, and do not indicate or imply relative importance or a specific order.

The terms “comprise”, “include”, and any other variation thereof are intended to cover a non-exclusive inclusion, which not only includes these elements listed, but also includes other elements not expressly listed.

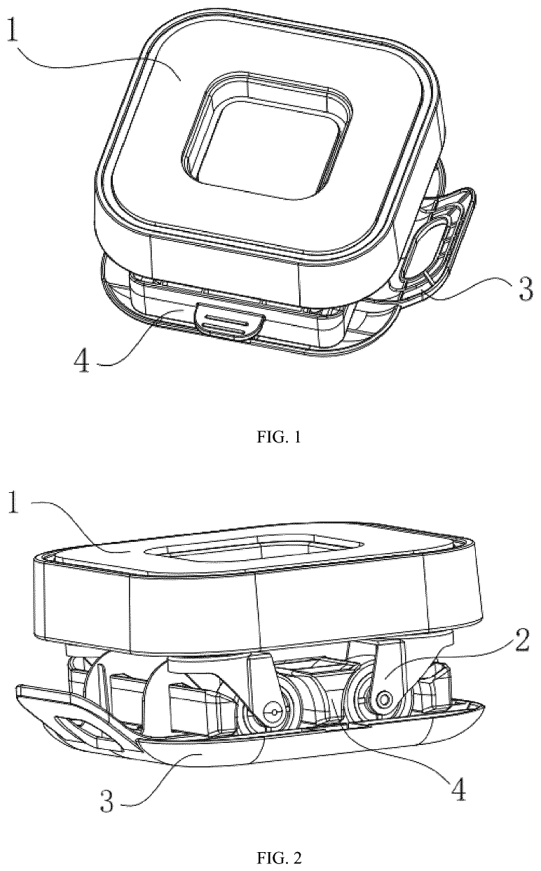

With reference to FIG. 1 and FIG. 2, a moving foot base of furniture provided in an embodiment of the present invention comprises: a base body 1, universal wheels 2 and a tray 3. A center of the base body 1 is provided with an accommodating cavity 11. The universal wheels 2 are mounted at a bottom portion of the base body 1, and the universal wheels 2 are rotatably connected with the base body 1. The base body 1 and the universal wheels 2 are all arranged on the tray 3.

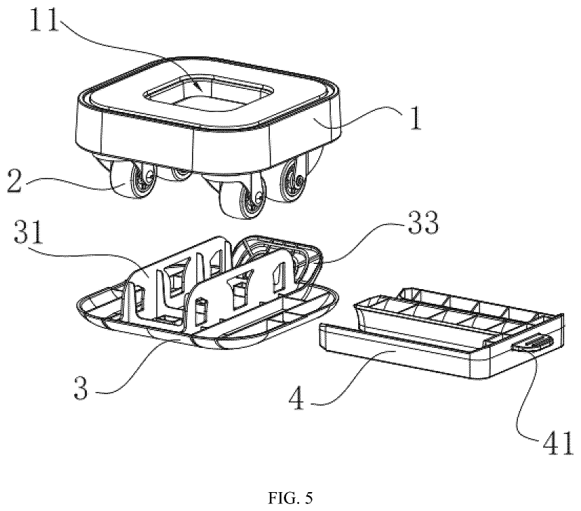

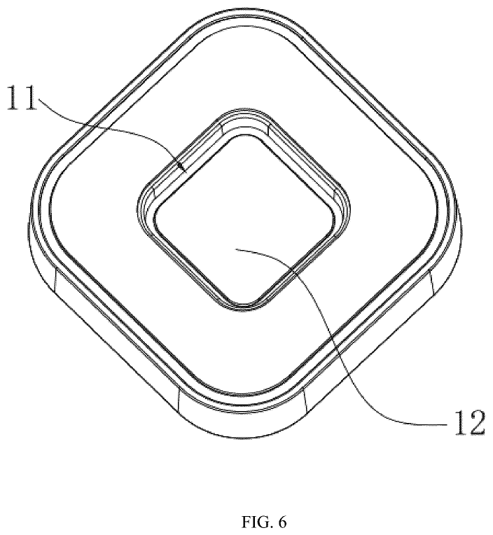

With reference to FIG. 1 to FIG. 5, in this embodiment, the base body 1 is preferably square, because the square base body 1 may be better fit with a wall face in a furniture placement environment, so as to save space. A center position of a top face of the base body 1 is provided with a square accommodating cavity 11. The accommodating cavity 11 is arranged in the center of the base body 1, which makes a supporting foot of furniture bear more uniform stress when being placed. Moreover, an area of the accommodating cavity 11 needs to be larger in design, so as to adapt to supporting feet of furniture with different sizes.

In the present application, the furniture is arranged in a direction of gravity on the moving foot base of furniture. Therefore, it can be understood that the top face, the bottom face, and the positions above and below mentioned in the present application are all based on the direction of gravity. In the direction of gravity, one side close to the ground is the bottom face or the position below, and one side far away from the ground is the top face or the position above.

After the supporting foot of furniture is placed in the accommodating cavity 11, a contact area between the furniture and a floor can be increased through the base body 1, so as to reduce a pressure on the floor, thereby avoiding the floor from being damaged. However, at this time, the furniture still faces the problem of difficult transportation, so that the universal wheels 2 are mounted on the bottom face of the base body 1 in this embodiment.

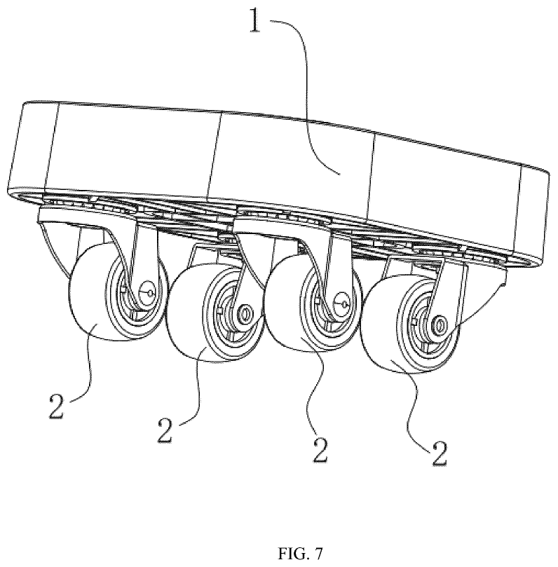

With reference to FIG. 6 and FIG. 7, the accommodating cavity 11 arranged on the top face of the base body 1 has a certain depth, so that a side face of the supporting foot of furniture can also obtain more supports after the supporting foot of furniture is placed in the accommodating cavity 11, which makes the supporting foot of furniture more stable after being placed. Meanwhile, in this embodiment, four universal wheels 2 are taken as an example for description. In different embodiments, a number of universal wheels 2 may also be adjusted, which will not be limited herein. Because the base body 1 is square, four universal wheels 2 are provided, and the four universal wheels 2 can be mounted at four corners of the bottom face of the base body 1 respectively, so as to make the base body 1 bear more uniform stress, thereby making the base body 1 move more smoothly under driving of the universal wheels 2. Meanwhile, an increase of the number of universal wheels 2 can also increase the contact area and reduce the pressure.

A sliding friction between the furniture and the floor is changed into rolling friction through the universal wheels 2, so as to greatly reduce a friction force, thereby making the furniture move more conveniently. A corresponding number of moving foot bases of furniture will be selected according to a number of supporting feet of furniture first, and then each supporting foot of furniture will be placed into one accommodating cavity 11 correspondingly. When all the supporting feet of furniture are placed into the accommodating cavities 11, the furniture may be directly pushed to move, and the whole moving process of the furniture is lighter through the rolling of the universal wheels 2, which can reduce investment of human resources. Moreover, the direct pushing of the furniture avoids manual transportation, and can also improve the safety of the furniture in the moving process.

However, there is originally a surface contact between the base body 1 and the floor. After the base body 1 is provided with the universal wheels 2, the base body 1 is in a point contact with the floor through the universal wheels 2, which reduces the contact area and increases the pressure. Therefore, in the present application, in order to protect the floor and prevent the floor from being damaged, the tray 3 is also arranged below the universal wheels 2. The base body 1 and the universal wheels 2 are all placed on the tray 3, so as to be in contact with the floor through the tray 3. The tray 3 has a larger bottom area, which increases the contact area with the floor and reduces the pressure. When the furniture needs to be moved, the universal wheels 2 may roll from the tray 3 to the floor, and then the furniture is moved.

In this embodiment, the supporting feet of furniture with different sizes are adapted through the accommodating cavity 11 first, and then the furniture is driven to move through the rolling of the universal wheels 2, so as to improve the movement convenience of the furniture. The load by the tray 3 increases the contact area with the floor and reduces the pressure, which avoids the floor from being damaged. Meanwhile, a bottom face of the tray 3 is designed into a smooth plane, which additionally provides an idea of moving furniture, so that the furniture can also be moved smoothly in a carpet environment, thereby improving the applicability of the moving foot base of furniture.

In one embodiment, the tray 3 is provided with a limiting plate 31, and the limiting plate 31 is provided with an inserting hole 32.

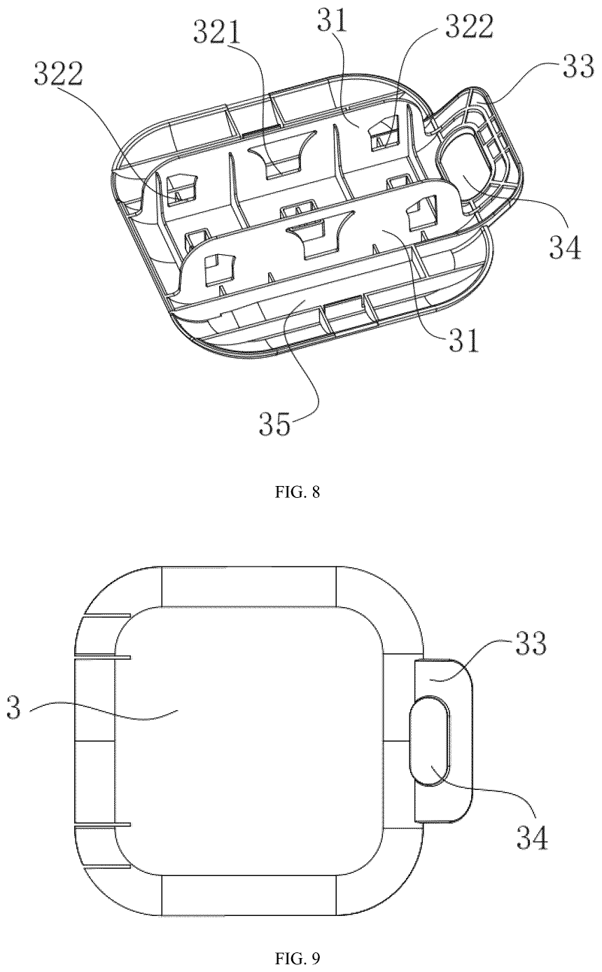

With reference to FIG. 1 to FIG. 8, four universal wheels 2 are taken as an example, and then the tray 3 is provided with a total of two limiting plates 31. As shown in FIG. 8, the two limiting plates 31 are fixedly connected to the tray 3, and a distance between the two limiting plates 31 corresponds to a distance between two adjacent universal wheels 2 in the same direction, so that when the universal wheels 2 roll onto the tray 3, the universal wheels 2 may move along surfaces of the limiting plates 31 in a length direction of the limiting plates 31. In a direction perpendicular to lengths of the limiting plates 31, because the limiting plates 31 abut against the universal wheels 2, the limiting plates 31 may limit the movement of the universal wheels 2 in this direction (the direction perpendicular to the lengths of the limiting plates 31).

In order to make a whole structure of the moving foot base of furniture more compact and beautiful, a size and a shape of the base body (1) are matched a size and a shape of the tray 3. As shown in FIG. 1 and FIG. 2, an edge around the base body (1) is a square with rounded corners, and an edge around the tray (3) is also a square with rounded corners, and the base body and the tray have the same size. When the wheels 2 are clamped into the tray 3, the overall structure is in a compact cube-like shape.

Further, as shown in FIG. 8, one side of each limiting plate 31 is further provided with a rail 35. Because the universal wheels 2 move along the limiting plates 31, the rails 35 are also arranged to be fit with the limiting plates 31. Positions of the rails 35 correspond to positions of the universal wheels 2, and when the universal wheels 2 roll onto the tray 3, the universal wheels 2 roll into the rails 35, so that the universal wheels 2 roll more smoothly. Meanwhile, a rolling direction of the universal wheels 2 may also be adjusted by cooperation between the limiting plates 31 and the rails 35.

In this embodiment, the movement of the universal wheels 2 is limited by the limiting plates 31, so as to make the universal wheels 2 more stable, thereby avoiding unnecessary movement of the universal wheels 2, and avoiding the furniture from being unstable after being placed.

In one embodiment, the moving foot base of furniture further comprises a latch 4, wherein the latch 4 penetrates through the limiting plate 31 via the inserting hole 32.

With reference to FIG. 1 to FIG. 11, because the universal wheels 2 need to be moved onto the tray 3, the limiting plates 31 do not completely limit the movement of the universal wheels 2. The universal wheels 2 may still move along the limiting plates 31 in the length direction of the limiting plates 31. Therefore, the latch 4 is also provided in this embodiment, and the movement of the universal wheels 2 in the length direction of the limiting plates 31 is limited by the latch 4.

Because the limiting plate 31 is provided with the inserting hole 32, the latch 4 can penetrate through the limiting plate 31. Meanwhile, the latch 4 needs to limit the movement of the universal wheels 2 in the length direction of the limiting plates 31, so that the latch 4 needs to be inserted in a direction perpendicular to the lengths of the limiting plates 31, so as to block the universal wheels 2. Moreover, after the universal wheels 2 are placed on the tray 3 stably, the latch 4 also needs to abut against the universal wheels 2, so as to avoid a gap between the universal wheels 2 and the latch 4, thereby avoiding the furniture from shaking caused by the universal wheels 2 rolling back and forth in the gap.

In one embodiment, the latch 4 comprises side inserting rods 402 and a middle inserting rod 401; the inserting hole 32 comprises side inserting ports 321 and a middle inserting port 322; and the middle inserting rod 401 penetrates through the middle inserting port 321, and the side inserting rods 402 penetrate through the side inserting ports 322.

With reference to FIG. 10 and FIG. 11, because four universal wheels 2 are taken as an example in the present application, and the four universal wheels 2 are divided into two groups in the direction perpendicular to the lengths of the limiting plates 31, the latch 4 is in a “W” shape in the present application, and the latch 4 comprises the middle inserting rod 401 and the side inserting rods 402. The middle inserting rod 401 is located in the middle, and the side inserting rods 402 are arranged on two sides respectively, so that the middle inserting rod 401 forms two clamping grooves with the side inserting rods 402 on two sides respectively.

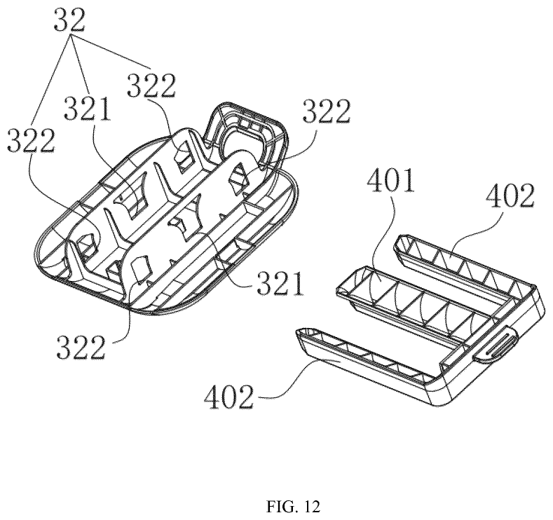

As shown in FIG. 12, in the process of inserting the latch 4 into the inserting hole 32, the middle inserting rod 401 needs to be aligned with the middle inserting port 321, the side inserting rods 402 on two sides need to be aligned with the side inserting ports 322 on two sides respectively, and then the latch 4 is inserted.

With reference to FIG. 2 to FIG. 5, after the universal wheels 2 drive the base body 1 to move onto the tray 3, the universal wheels 2 are limited by abutting against the limiting plates 31 first, and then, after the latch 4 is inserted into the inserting holes 32 in the limiting plates 31, the latch 4 abuts against the universal wheels 2 in a second direction. As shown in FIG. 2, peripheral sides of the universal wheels 2 are all abutted by the limiting plates 31 and the latch 4, so as to limit the universal wheels 2, thereby ensuring the stability of the universal wheels 2 when the furniture does not need to be moved, so that the furniture can keep stable after being moved without shaking. Similarly, when the furniture needs to be moved, the latch 4 needs to be taken out of the inserting holes 32 first, and then the universal wheels 2 are moved to realize the movement of the furniture.

In this embodiment, the universal wheels 2 are further limited by the latch 4, so as to improve the stability of the universal wheels 2 in a state of rest.

In one embodiment, when the latch 4 completely penetrates through the limiting plate 31 via the inserting hole 32, a wheel accommodating groove 36 is formed among the middle inserting rod 401, the side inserting rods 402 and the limiting plate 31, the universal wheels 2 are limited in the wheel accommodating grooves 36, and the universal wheels 2 are in a non-rollable state.

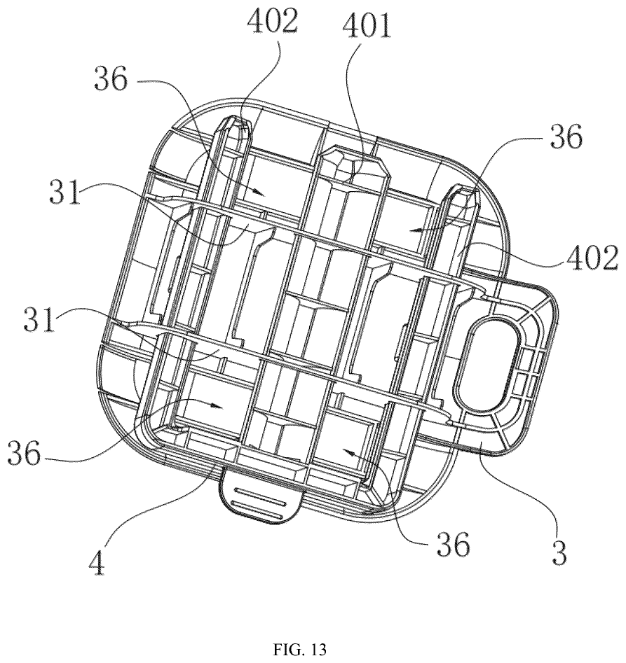

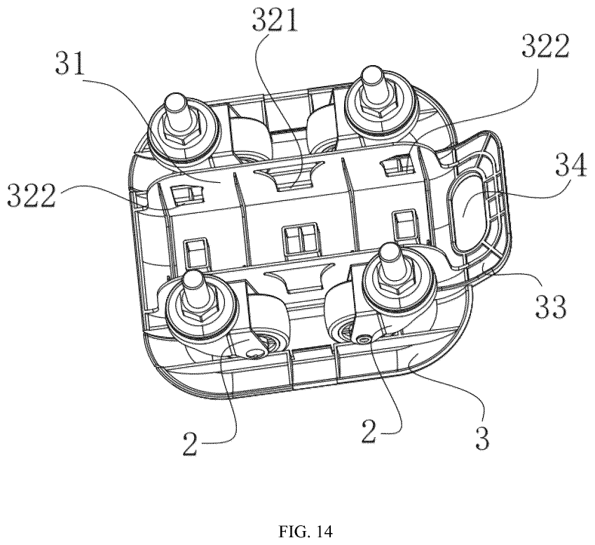

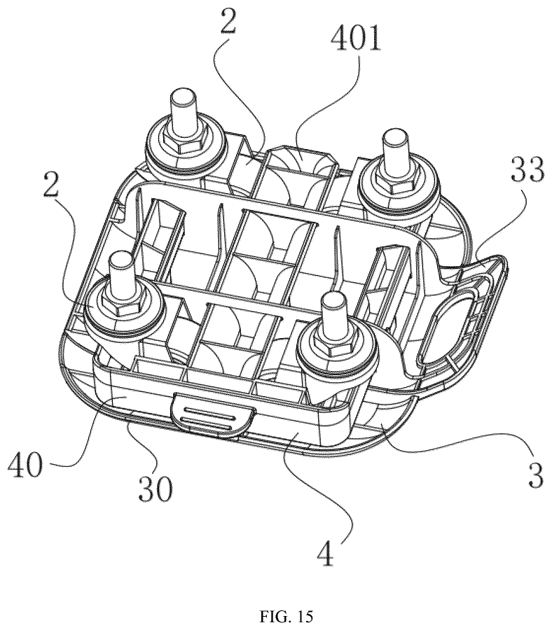

As shown in FIG. 13, after the latch 4 is assembled with the tray 3, the latch 4 in the “W” shape is divided into four wheel accommodating grooves 36 by two limiting plates 31. Because the latch 4 and the limiting plates 31 remain relatively fixed, frames of the wheel accommodating grooves 36 also remain fixed. As shown in FIG. 14 and FIG. 15, after the universal wheels 2 are placed in the wheel accommodating grooves 36, peripheries of the universal wheels 2 abut against the latch 4 or the limiting plates 31, and the latch 4 and the limiting plates 31 remain relatively fixed, so that the universal wheels 2 are also limited after being abutted, thereby being unable to move. Therefore, after the latch 4 is inserted into the inserting holes 32 to form the wheel accommodating grooves 36 with the limiting plates 31, the universal wheels 2 are in the non-rollable state.

In one embodiment, the latch 4 is further provided with a handle 41, and when the universal wheels 2 are in the non-rollable state, the handle 41 is used for removing the latch 4; an edge of the tray 3 is provided with a pulling portion 33, and when the universal wheels 2 are in the non-rollable state, the pulling portion 33 is used for removing the tray 3; and when the tray 3 and the latch 4 are both removed, the universal wheels 2 are in a rollable state.

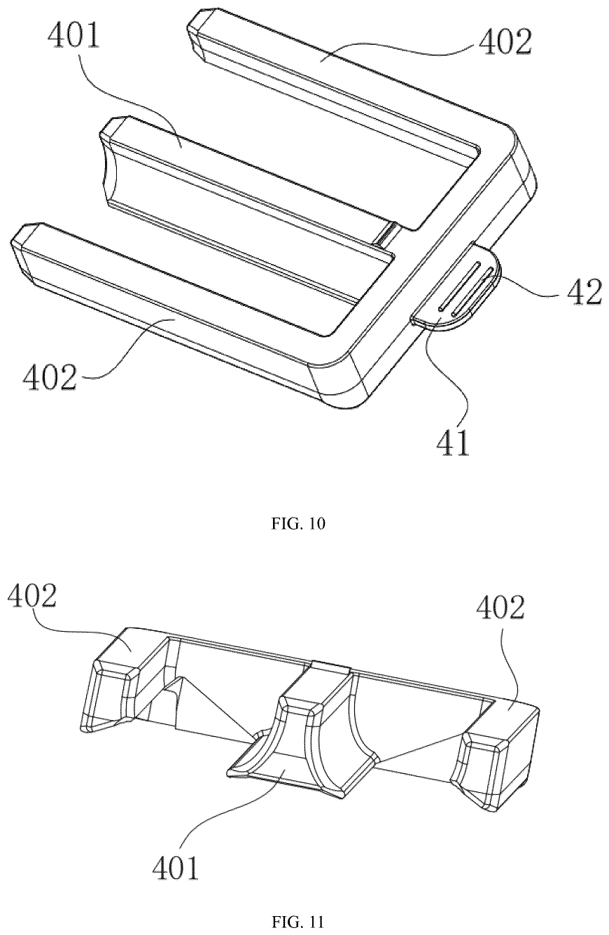

As shown in FIG. 10, a rear end of the latch 4 is provided with the handle 41. Because the latch 4 needs to be moved when locking or unlocking the universal wheels 2, so that the handle 41 is designed on the latch 4, which is convenient for taking the latch 4. As shown in FIG. 8 and FIG. 9, one side face of the tray 3 is provided with the pulling portion 33 extending outwards, which is convenient for taking the tray 3. When the furniture needs to be moved, the latch 4 is pulled out from the tray 3 through the handle 41 first, so as to release one limitation on the universal wheels 2, and then, the tray 3 is removed through the pulling portion 33, so as to release the other limitation on the universal wheels 2. At this time, the universal wheels 2 move away from the wheel accommodating grooves 36 to enter the floor, and are in the rollable state, so that the furniture can be driven to move.

In one embodiment, when the latch 4 completely penetrates through the limiting plate 31 via the inserting hole 32, and a first edge 40 of the latch 4 is aligned with a first edge 30 of the tray 3. As shown in FIG. 15, when the universal wheels 2 stop moving, and need to remain stationary to be in the non-rollable state, the universal wheels 2 roll into the tray 3 first, and then the latch 4 penetrates through the limiting plates 31 via the inserting holes 32. At this time, the first edge 40 of the latch 4 is aligned with the first edge 30 of the tray 3, which can reduce an outward protruding distance of the latch 4, so as to save space.

In one embodiment, the pulling portion 33 is arranged obliquely upwards; and the pulling portion 33 is provided with a pulling hole 34. The pulling portion 33 is arranged obliquely upwards, because the tray 3 is in contact with the floor, and a height of the tray 3 is small, so that the pulling portion 33 arranged obliquely upwards can have a larger height, thereby being more convenient for an operator to grab the pulling portion 33.

Further, because the whole furniture is finally loaded by the tray 3, the tray 3 bears a greater pressure, and a larger force needs to be exerted when grabbing the tray 3. Therefore, in this embodiment, the pulling portion 33 is provided with the pulling hole 34, so that the operator may grab the tray 3 with the help of an additional operating tool. For example, a power-assisted pulling rope is used to penetrate through the pulling hole 34, so that the operator may move the tray 3 more conveniently.

In one embodiment, an end face of the handle 41 is further provided with a friction portion 42, and the friction portion 42 protrudes from the end face of the handle 41. As shown in FIG. 10, the handle 41 is further provided with the friction portion 42, and the friction portion 42 slightly protrudes on the handle 41, which increases a contact area when taking the latch, and increases a friction force, thereby improving the stability when taking the latch 4.

In one embodiment, a bottom face of the tray 3 is a plane. In one embodiment, the tray 3 is made of a hard material.

Generally, floors of families are all a smooth plane, so that the universal wheels 2 can roll smoothly on the floor. However, floors of some families may be covered with carpets and other furniture articles, and the carpets are mostly made of a plush material, so that a friction coefficient of a whole carpet is large. At this time, the rolling of the universal wheels 2 on the carpet may be blocked, and more seriously, the carpet may be damaged. As shown in FIG. 9, in this embodiment, the bottom face of the tray 3 is a smooth plane, that is, the surface of the tray 3 in contact with the floor is a smooth plane. In a carpet covering environment, the universal wheels 2 may roll onto the tray 3, and then the tray 3 slides on the carpet to drive the whole furniture to move, which can not only make the furniture move more smoothly, but also avoid the carpet from being damaged. Because the tray 3 is a part that is finally in contact with the floor and bears a weight of the whole furniture, the tray 3 is made of the hard material, which ensures that the tray 3 has sufficient strength and rigidity, so as to prolong the service life, thereby avoiding frequent replacement caused by damage.

In one embodiment, a surface of the latch 4 oriented to the universal wheels 2 is cambered, so as to be fit with the universal wheels 2. In one embodiment, a cushion pad 12 is further arranged in the accommodating cavity 11.

With reference to FIG. 10 and FIG. 11, because the latch 4 abuts against the universal wheels 2 perpendicular to a rolling direction of the universal wheels 2, the latch 4 abuts against arc rolling surfaces of the universal wheels 2. When the universal wheels 2 are locked, the surface of the latch 4 oriented to the universal wheels 2 is also designed into an arc surface, so that the latch 4 is more fit with the universal wheels 2, the contact area between the latch 4 and the universal wheels 2 is increased, and the pressure generated when the latch 4 abuts against the universal wheels 2 is reduced, thereby protecting the universal wheels 2.

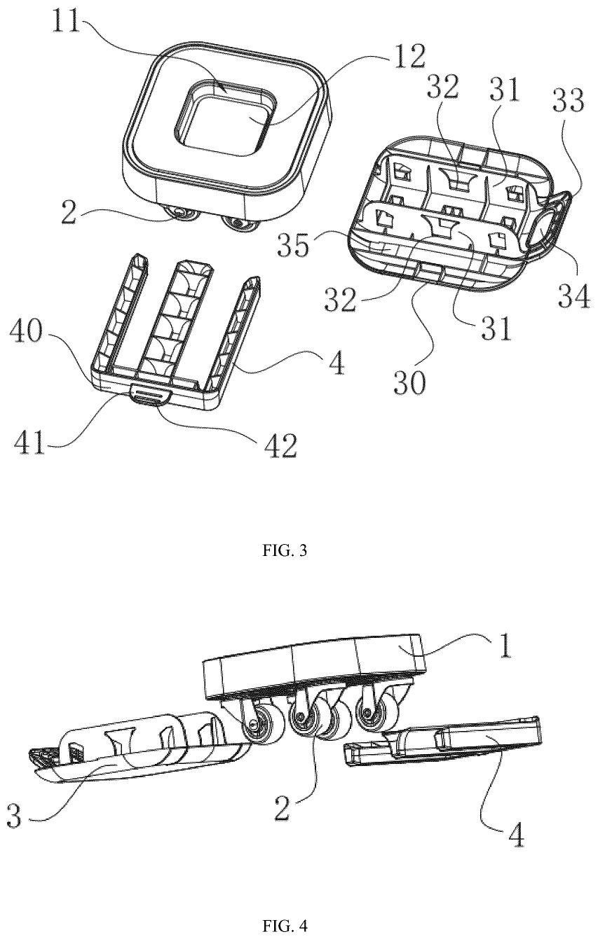

With reference to FIG. 3 and FIG. 6, because the supporting foot of furniture needs to be placed in the accommodating cavity 11, and the furniture is generally a product with a heavy weight, when the supporting foot of furniture is placed in the accommodating cavity 11, a large pressure may be exerted on the base body 1. When the base body 1 bears the large pressure, an overall structural strength of the base body 1 stands a severe test. Therefore, in order to avoid the base body 1 from being damaged after bearing the pressure, the cushion pad 12 is arranged in the accommodating cavity 11 in this embodiment. After the supporting foot of furniture is placed in the accommodating cavity 11, the supporting foot of furniture is in contact with the cushion pad 12 first, and the cushion pad 12 is generally made of an elastic material, so that an impact of heavy furniture on the base body 1 may be cushioned by the cushion pad 12, thereby protecting the base body 1.

In one embodiment, a front end of the latch 4 is provided with a chamfer in a direction that the latch 4 penetrates through the inserting hole 32. With reference to FIG. 10 and FIG. 11, because the latch 4 needs to move towards the universal wheels 2 and then is inserted into the inserting hole 32, when the latch 4 is not aligned with the inserting hole 32, the latch 4 may collide with the universal wheels 2, causing damage to the universal wheels 2. Therefore, in this embodiment, the front end of the latch 4 is chamfered, and only one side of the latch 4 oriented to the universal wheels 2 is chamfered.

When the latch 4 moves towards the universal wheels 2, because the front end of the latch 4 is chamfered, the front end of the latch 4 has a larger gap, so as to avoid collision with the universal wheels 2. Meanwhile, after being chamfered, the front end of the latch 4 is also inclined. Even if the front end of the latch collides with the universal wheels 2, the universal wheels 2 can also abut against the inclined plane, and then move relative to the latch 4 along the inclined plane until the latch 4 is adjusted to a correct direction.

In this embodiment, the process of inserting the latch 4 into the inserting hole 32 is safer by chamfering.

The above are merely the specific embodiments of the present invention, but the scope of protection of the present invention is not limited to the specific embodiments. Those skilled in the art may easily think of changes or substitutions within the technical scope disclosed by the present invention, and all the changes or substitutions should be included in the scope of protection of the present invention. Therefore, the scope of protection of the present invention should be subject to the appended claims.

We claim:

1. A moving foot base of furniture, comprising:
a base body, wherein a center of the base body is provided with an accommodating cavity;
universal wheels, wherein the universal wheels are mounted at a bottom portion of the base body, and the universal wheels are rotatably connected with the base body; and
a tray, wherein the base body and the universal wheels are all arranged on the tray.

2. The moving foot base of furniture according to claim 1, wherein the tray is provided with a limiting plate, and the limiting plate is provided with an inserting hole.

3. The moving foot base of furniture according to claim 2, further comprising a latch, wherein the latch penetrates through the limiting plate via the inserting hole.

4. The moving foot base of furniture according to claim 3, wherein the latch comprises side inserting rods and a middle inserting rod;
the inserting hole comprises side inserting ports and a middle inserting port; and
the middle inserting rod penetrates through the middle inserting port, and the side inserting rods penetrate through the side inserting ports.

5. The moving foot base of furniture according to claim 4, wherein, when the latch completely penetrates through the limiting plate via the inserting hole, a wheel accommodating groove is formed among the middle inserting rod, the side inserting rods and the limiting plate, the universal wheels are limited in the wheel accommodating grooves, and the universal wheels are in a non-rollable state.

6. The moving foot base of furniture according to claim 5, wherein the latch is further provided with a handle, and when the universal wheels are in the non-rollable state, the handle is used for removing the latch;
an edge of the tray is provided with a pulling portion, and when the universal wheels are in the non-rollable state, the pulling portion is used for removing the tray; and
when the tray and the latch are both removed, the universal wheels are in a rollable state.

7. The moving foot base of furniture according to claim 5, wherein, when the latch completely penetrates through the limiting plate via the inserting hole, a first edge of the latch is aligned with a first edge of the tray.

8. The moving foot base of furniture according to claim 6, wherein the pulling portion is arranged obliquely upwards; and the pulling portion is provided with a pulling hole.

9. The moving foot base of furniture according to claim 6, wherein an end face of the handle is further provided with a friction portion, and the friction portion protrudes from the end face of the handle.

10. The moving foot base of furniture according to claim 1, wherein a bottom face of the tray is a plane.

11. The moving foot base of furniture according to claim 1, wherein the tray is made of a hard material.

12. The moving foot base of furniture according to claim 3, wherein a surface of the latch oriented to the universal wheels is cambered, so as to be fit with the universal wheels.

13. The moving foot base of furniture according to claim 1, wherein a cushion pad is further arranged in the accommodating cavity.

14. The moving foot base of furniture according to claim 3, wherein one end of the latch has a chamfered structure.
